(19) United States
(12) Patent Application Publication
(10) Pub. No.: US 2021/0069618 A1
(43) Pub. Date: Mar. 11, 2021

(54) Filter System and Filter Element with Fiberglass-Containing Filter Medium and Wound Body Fiberglass-Barrier

(71) Applicant: MANN+HUMMEL GmbH, Ludwigsburg (DE)

(72) Inventor: Lars Spelter, Ditzingen (DE)

(21) Appl. No.: 17/098,616

(22) Filed: Nov. 16, 2020

Related U.S. Application Data
(63) Continuation of application No. PCT/EP2019/062152, filed on May 13, 2019.

(30) Foreign Application Priority Data
May 16, 2018 (DE) 10 2018 111 797.3

(51) Int. Cl. B01D 29/21; B01D 39/20; F02M 37/34

(52) U.S. Cl. CPC B01D 29/216; B01D 39/2017; F02M 37/34; B01D 2239/1216; B01D 2239/0618; B01D 2239/0622; B01D 2239/1258; B01D 2201/0415

(57) ABSTRACT

A filter system with a filter housing that has an inlet for the fluid to be filtered and an outlet for the filtered fluid. A filter element is arranged in the filter housing and is provided with a fiberglass-containing filter medium. A fiberglass barrier for retaining fiberglass particles contained in the filtered fluid is arranged fluidically downstream of the fiberglass-containing filter medium. The fiberglass barrier is a wound body of a wound filter material with an average pore size of smaller than 20 μm. The wound body has a maximum winding thickness of 1.5 mm.

### CROSS-REFERENCE TO RELATED APPLICATIONS

This application is a continuation application of international application No. PCT/EP2019/062152 having an international filing date of 13 May 2019 and designating the United States, the international application claiming a priority date of 16 May 2018 based on prior filed German patent application No. 10 2018 111 797.3, the entire contents of the aforesaid international application and the aforesaid German patent application being incorporated herein by reference.

### BACKGROUND OF THE INVENTION

The invention concerns a filter system and a filter element for filtering a fluid that are provided with a fiberglass-containing filter medium. The filter system and the filter element are preferably usable in motor vehicles, in particular for filtering fuel or oil, but also in hydraulic systems.

Fiberglass-containing filter media are characterized by their good chemical resistance and provide moreover a good filtration performance in regard to small and smallest particulate contaminants contained in the fluid to be filtered. For the aforementioned reasons, such fiberglass-containing filter media are established for filtering chemically aggressive fluids, for example, fuels for diesel and Otto engines. In practice, one must counteract a discharge of fiberglass fibers or fiberglass particles from the filter system or the filter element by which a device arranged fluidically downstream of the filter element in operational use, for example, high-pressure injection pumps of an internal combustion engine, can become damaged. In practice, the fiberglass-containing filter media therefore comprise occasionally a barrier layer for fiberglass that is integrated into the filter medium. However, an undesirable contamination of the clean side of the known barrier layer with fiberglass fibers or fiberglass particles may occur due to mechanical loading of the fiberglass-containing filter medium when manufacturing the fiberglass-containing filter medium, in particular when tailoring or folding the filter medium. As a result, even larger fiberglass particles which may have easily a length of up to 1 mm and a diameter of up to 20 μm may be discharged with the filtered fluid from the filter element/filter system in filtering operation. The risk of damaging component groups arranged fluidically downstream of the filter element/filter system is therefore not eliminated by the known fiberglass barrier layer.

For retaining fiberglass particles, the filter system disclosed in DE 10 2015 006 766 A1 discloses a sinter body which is embodied separate from the fiberglass-containing filter medium and is arranged fluidically downstream of the fiberglass-containing filter medium. By means of such a sinter body, the flow resistance for the filtered fluid is significantly increased. When the sinter bodies are manufactured of a plastic material, they can indeed be produced relatively inexpensively. However, due to the material shrinkage entailed in the sintering process, such sinter bodies can be produced only to a limited extent with the sufficient dimensional stability. Therefore, providing a fluid-tight connection of the sinter body at the filter housing or at the filter element is difficult. The sinter bodies must therefore be recalibrated often or considerable sealing measures must be undertaken in order to reliably prevent an undesirable bypass flow of fluid contaminated with fiberglass particles around the sinter body. Moreover, the sinter bodies in general require a relatively large installation space and, moreover, must be held available in numerous sizes and shapes in order to be able to furnish different filter elements/filter systems therewith.

### SUMMARY OF THE INVENTION

It is therefore the object of the invention to provide a filter system as well as a filter element in which an undesirable discharge of fiberglass particles can be reliably counteracted and, in this context, which are producible simply and inexpensively, and wherein the flow resistance upon flow through the filter medium is affected only to a minimal degree.

The object concerning the filter system is solved by a filter system with a filter housing that includes an inlet for the fluid to be filtered and an outlet for the filtered fluid; with a filter element arranged in the filter housing that Includes a fiberglass-containing filter medium; and with a fiberglass barrier for retaining fiberglass particles contained in the filtered fluid being arranged fluidically downstream of the fiberglass-containing filter medium; wherein the fiberglass barrier is in the form of a wound body that includes a wound filter material with an average pore size of smaller than 20 μm and a maximum winding thickness d of 1.5 mm.

The filter element according to the invention Includes a fiberglass-containing filter medium and a fiberglass barrier for retaining fiberglass particles contained in the filtered fluid being arranged fluidically downstream of the fiberglass-containing filter medium. The fiberglass barrier is embodied in the form of a wound body that includes a wound filter material with an average pore size of smaller than 20 μm and a maximum winding thickness d of 1.5 mm.

Preferred further embodiments of the invention are subject matter of the dependent claims.

The filter system according to the invention serves for filtering a fluid, in particular fuel or oil, for example, for an internal combustion engine of a motor vehicle but also the oil of a hydraulic unit. This filter system includes a filter housing with an inlet for the fluid to be filtered and with a drain for the filtered fluid. In the filter housing, a filter element with a fiberglass-containing filter medium is arranged. A fiberglass-containing filter medium is to be understood as a filter medium that partially or as a whole is comprised of fiberglass. The filter system includes a fiberglass barrier element, embodied separate from the fiberglass-containing filter medium, for retaining fiberglass particles that may be contained in the fluid which is guided through the fiberglass-containing filter medium. The fiberglass barrier element according to the invention is embodied as a wound body which Includes a wound filter material with an average pore size that is smaller than 20 μm and wherein the wound body has a maximum winding thickness d (of the wound filter material) of 1.5 millimeter.

Since the wound body is configured as a component that is embodied separate from the fiberglass-containing filter medium, the wound body can be produced without any exposure to the fiberglass particles. An undesirable contamination of the fiberglass barrier element can thus be reliably prevented. It is understood that the wound body is comprised of a filter material which is resistant to the fluid to be filtered. For example, when the fluid to be filtered is diesel fuel, the filter material can be in particular PET (polyethylene terephthalate) or PBT (polybutylene terephthalate). It should be noted that PBT is also suitable for filtering oil. Due to the average pore size of the filter material of the wound body of smaller than 20 μm, larger fiberglass fibers or fiberglass particles that are particularly a high risk for devices or components arranged fluidically downstream of the filter element can be reliably filtered out of the fluid that has been filtered by the fiberglass-containing filter medium. This holds true in particular for fiberglass particles with a maximum size (=Feret diameter) of larger than 200 μm. The average pore size of the filter material is determined in practice in general indirectly by means of the so-called “bubble point” testing method. For the “bubble point” testing method, a sample of the filter material is clamped at the rim in a so-called round blank holder seal-tightly about the circumference and immersed in a suitable testing liquid, such as petroleum ether or alcohol. The filter material is loaded from below with air pressure. The air pressure value at which a continuous air bubble discharge above the filter material (macroscopic) is detected is the so-called bubble point. The average pore size of the filter material can be calculated based on the bubble point.

Due to the minimal winding thickness of the wound body, an excessive pressure loss across the fiberglass barrier can be prevented in filtering operation. Moreover, the fiberglass barrier itself can be realized in a rather limited installation space of the filter system or filter element. This is advantageous for the scope of application.

Since the average pore size of the filter material amounts to less than 20 μm, in particular also smaller fiberglass particles with a maximum size (=Feret diameter) between 50 μm and 200 μm can be retained efficiently by the fiberglass barrier.

The pore size of the wound body can therefore be larger than a cross section of the fiberglass particles of the filter medium contained in the fluid and to be retained. In this way, an unnecessary increase of the flow resistance across the wound body can be avoided and, at the same time, an effective retention of fiberglass particles contained in the fluid filtered by the fiberglass-containing filter medium is enabled. This is achieved by the structure as well as optionally multiple windings of the filter material, in particular of the fiber nonwoven.

According to the invention, the thickness of an individual layer of the filter material according to the invention, in particular of the fiber nonwoven, can amount to between 0.1 mm and 1.5 mm, preferably 0.1 mm to 0.24 mm, preferably approximately 0.2 mm.

According to the invention, the wound body includes at least one complete winding of the filter material. According to further preferred embodiments, the wound body as a function of the thickness of the filter material, i.e., an individual layer of the filter material, can also comprise 2, 3 or 4 windings of the filter material. By means of the number of windings as well as by means of the average pore size of the filter material, the desired retention capacity for the fiberglass particles to be separated from the fluid can be adjusted so as to meet the requirements.

The filter material is preferably a synthetic filter material web, in particular a fiber nonwoven (=“non-woven”). According to alternative embodiments of the invention, the filter material can also be a woven material and/or knit material. By means of such textile webs, it can be ensured in a simple and reliable manner that the fluid flowing through the filter system flows through the wound body about the entire circumference before it flows through the outlet opening of the filter housing out of the filter housing.

Moreover, such textile materials are well suited for filtration purposes and are available on the market as rolled goods made from different natural and synthetic fibers. Moreover, they can be inexpensively purchased and processed. The filter material according to the invention, in particular fiber nonwoven, can be produced, for example, by way of the so-called meltblown method.

The air permeability of the filter material according to the invention, in particular fiber nonwoven, of the wound body, can amount to preferably 10 to 80 l/(cm²*s), preferably <50 l/(cm²*s), particularly preferred <30 l/(cm²*s) (according to DIN EN ISO 9237).

The grammage of the filter material, in particular of the fiber nonwoven, preferably amounts to 20 to 200 g/m² (according to DIN EN ISO 536).

The wound body according to the invention is preferably designed to filter fiberglass particles with a length L of more than 200 μm length completely or substantially completely out of the fluid. Particularly preferred, by means of the wound body, fiberglass particles with a length between 50 μm and 200 μm can be separated from the fluid by more than 95%.

The wound body can be wound, for example, about a preferably sleeve-type support body. It is possible to thereby avoid in the pressure-loaded operating state undesirable deformations or damages of the wound body through which the retention capacity of the wound body in regard to the fiberglass particles contained in the fluid would be compromised.

The support body is preferably an integral component of the filter housing or of the filter element. In the first case, the support body together with the filter housing forms a structural unit. When the filter housing is a so-called lifetime component of a vehicle or the like, the support body is embodied also as such a lifetime component. The support body can be embodied together with the filter housing or a filter housing part in particular as one piece or locked with the filter housing, preferably non-detachably. A non-detachable locking action is presently understood as such a locking connection that cannot be unlocked without destroying one of the locking elements that form the locking connection. When the filter element is exchanged, the support body remains at the filter housing in all cases. When the support body is an integral component of the filter element, the support body together with the filter element forms a structural unit to be handled jointly and exchangeable in intervals.

The support body can be in particular embodied as a grid-shaped central tube of the filter element or of the filter housing as it serves in practice usually for inward support of the filter medium of the filter element. In this way, the material usage for the fiberglass barrier element and thus the manufacturing costs of the filter system as a whole can be kept low. The connection of the windings or winding layers relative to each other or to the support body can be realized, for example, by means of an adhesive and/or by ultrasonic welding.

The filter element according to the invention serves for filtering fuel or oil and Includes a fiberglass-containing filter medium as well as a fiberglass barrier for retaining fiberglass fibers contained in the filtered fluid, arranged fluidically downstream of the fiberglass-containing filter medium and embodied as a wound body.

The above explanations, in particular in regard to the embodiments according to the invention of the filter material and of the wound body apply correspondingly to the filter element according to the invention.

### BRIEF DESCRIPTION OF THE DRAWINGS

Further features and advantages of the invention result from the following detailed description of an embodiment of the invention, from the claims as well as based on the Figures of the drawing which illustrate details important to the invention. The various features can be realized individually by themselves or several thereof in any combinations in variants of the invention. The features illustrated in the drawing are illustrated such that the particularities according to the invention can be made visible clearly.

FIG. 1 shows in a section illustration a filter system comprising a filter housing, only schematically illustrated, as well as a filter element arranged in the filter housing with a fiberglass-containing filter medium, wherein the filter system Includes a fiberglass barrier in the form of a wound body, which is embodied separate from the fiberglass-containing filter medium and is arranged fluidically downstream thereof.

FIG. 2 shows the filter system according to FIG. 1 in a section illustration and in the mounted state at a filter head.

FIG. 3 shows the wound body of the filter element according to FIG. 1 with partially unwound fiber nonwoven web in a partially perspective illustration.

FIG. 4 shows a bar diagram with illustration of the measured particle number of fiberglass particles contained in a fluid flowing through a fiberglass-containing filter medium, plotted against the maximum Feret diameter of the fiberglass particles.

FIG. 5 shows a bar diagram with illustration of the measured fiberglass particle number after filtration of the fiberglass particle-containing fluid by means of a fiberglass barrier according to FIG. 1, plotted against the maximum Feret diameter of the fiberglass particles.

### DESCRIPTION OF PREFERRED EMBODIMENTS

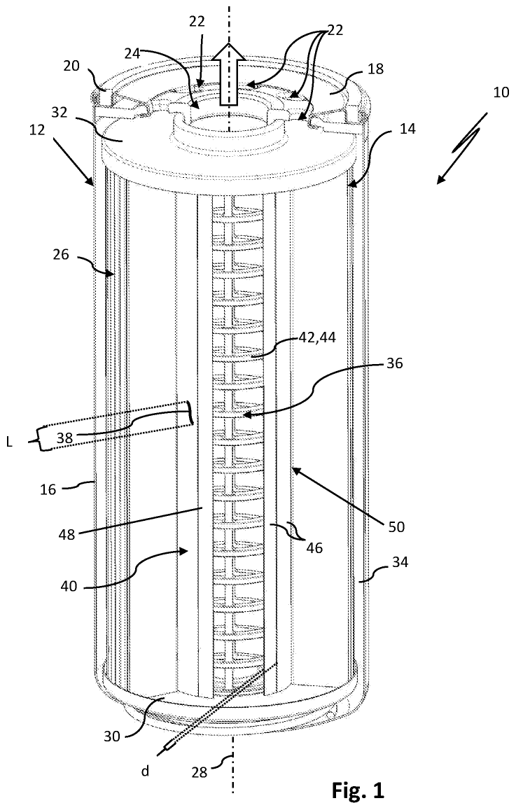

FIG. 1 shows a filter system 10 having a filter housing 12 and a filter element 14 that is arranged in the filter housing 12. The filter housing 12 included a housing pot 16 with an annular cover 18 that is crimped onto the housing pot 16 and at which an annular sealing element 20 is held. The filter housing 12 includes here an inlet with a plurality of inlet openings 22 and a centrally arranged outlet 24 for a fluid to be filtered, in particular fuel or oil.

The filter element 14 is embodied here in an exemplary fashion as a round filter element and includes a fiberglass-containing filter medium 26. In other words, the fiberglass-containing filter medium 26 can comprise fiberglass or be comprised as a whole of fiberglass. The fiberglass-containing filter medium 26 is arranged relative to the longitudinal axis 28 of the filter element 14 in an annular shape and can be folded, for example, in a star shape. The fiberglass-containing filter medium 26 is arranged here between a first end disk 13 and a second end disk 32 of the filter element 14. The fiberglass-containing filter medium 26 can be glued or welded to the two end disks 30, 32 or can be arranged, held by being embedded, in the material of the two end disks 30, 32 in order to ensure a fluid-tight connection of the fiberglass-containing filter medium 26 to the end disks 30, 32.

Caused by manufacture, fiberglass particles can be discharged from the fiberglass-containing filter medium 26 and can thus contaminate the fluid filtered by the fiberglass-containing filter medium 26 at the clean side of the filter element 14. An individual fiberglass particle 38 is illustrated in FIG. 1 disproportionately large for illustration purposes. It should be noted that the fiberglass particles 38 in reality in longitudinal direction can comprise a length of up to several millimeters and an (average) thickness, measured transversely to the longitudinal direction, of more than 10 μm.

The filter element 14 Includes in the embodiment illustrated in FIG. 1 a fiberglass barrier that is embodied as a wound body 40. The wound body 40 is arranged fluidically downstream of the fiberglass-containing filter medium 26 in order to prevent an undesirable discharge of fiberglass particles 38 from the filter element 14 and thus out of the outlet 24 of the filter housing 12. The wound body 40 is presently embodied as an integral component of the filter element 14 and forms therewith a common component unit that can be handled jointly. The wound body 40 is arranged here on a support body 42 in the form of a grid-shaped central tube 44 of the filter element 14 as it serves in conventional filter elements 14 for reinforcement of the filter element 14 and/or radial inward support of the fiberglass-containing filter medium 26.

The wound body 40 includes preferably a plurality of windings 46 of a filter material 48. The maximum winding thickness d of the wound body 40 in each case amounts to between 0.1 millimeter and 1.5 millimeter, wherein an individual layer of the filter material 48 as a function of the number of windings 46 of the filter material 48 amounts to between 0.1 millimeter and 1.5 millimeter. The wound body 40 includes in this context between one and four, here two windings 46 of the filter material 48, for example.

The fiberglass-containing filter medium 26 can be supported at the central tube 44 by means of the wound body 40 in a radial direction in relation to the longitudinal axis 28 of the filter element 14. Alternatively, between the fiberglass-containing filter medium 26 and the wound body 40, a gap 50—even though only small—can be formed which surrounds the wound body preferably completely in a radial direction in relation to the longitudinal axis 28. In the latter case, the fiberglass medium 26 is arranged, at least in the state without pressure loading, spaced apart from the wound body 40 in the radial direction. The wound body 40 can be flowed through in the radial direction in relation to the longitudinal axis 28 of the filter element 14 by the filtered fluid and can be integrated into the material of at least one, preferably of both end disks 30, 32 of the filter element 14, in particular embedded, but can also be glued or welded thereto.

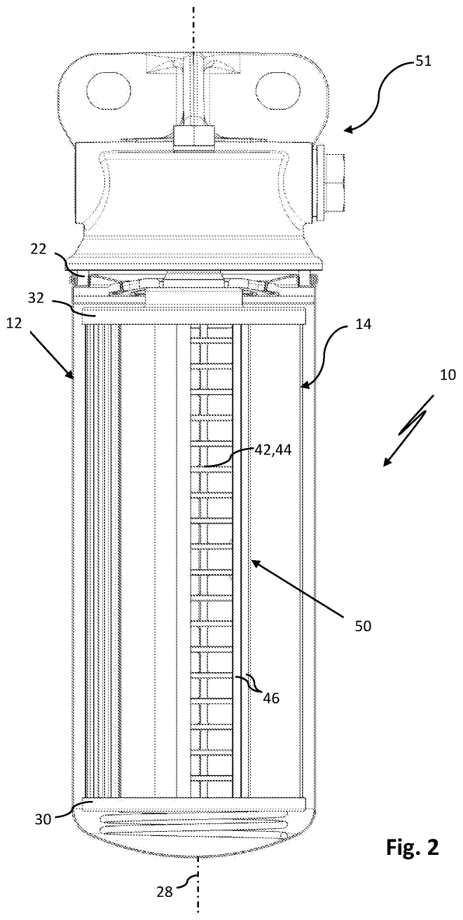

In FIG. 2, the filter system 10 is shown in a section illustration and in a suspended mounted state at the filter head 51. The filter head 51 serves in a generally known manner to supply the fluid to be filtered to the filter system 10 and to guide the fluid that has been filtered by means of the filter system 10 away from the filter system 10. Due to the annular sealing element 22, a sufficient seal-tight seat of the filter system 10 at the filter head 51 is ensured. It is understood that the filter system 10 can also be designed for a so-called upright mounting at the filter head 51.

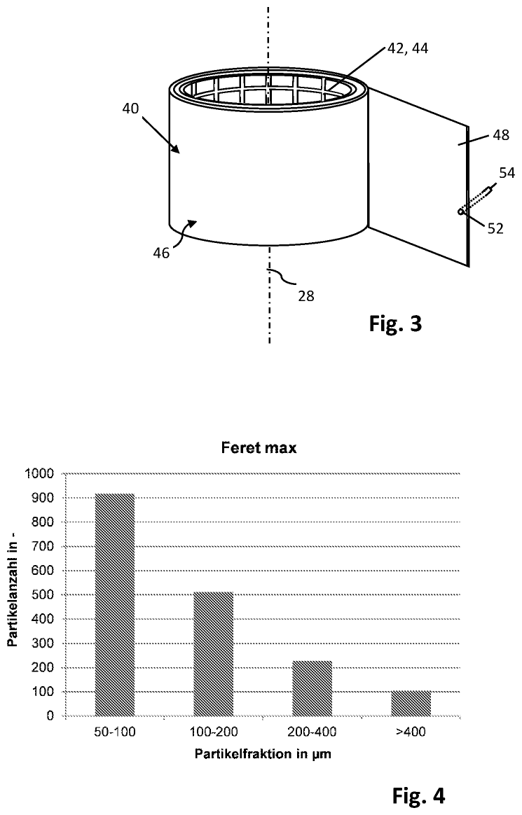

FIG. 3 shows the support body 42 embodied as a central tube 44 with the wound body 40, immediately wound thereon, of the filter element 14 according to FIG. 1 in a partial detail illustration and with partially unwound filter material 48. The filter material 48 is designed here as a nonwoven of so-called meltblown fibers. Alternatively, the filter material 48 of the wound body can be designed as a knit material, knotted material, or as a woven material, for example, in so-called sateen, linen or twill weave.

The retention capacity of the wound body 40 with regard to fiberglass fibers 38 (FIG. 1) substantially depends on the average pore size 52 of the filter material 48 as well as the number of the windings 46 of the filter material 48 on the support body 42. The average pore size 52 of the filter material 48 is here larger than an average diameter (not shown in the Figures) of the fiberglass particles 38 to be retained. In this way, the flow resistance of the wound body 40 for the fluid can be minimized. The rigid fiberglass particle 38, due to its inherent bending stiffness, in general cannot be deformed even at a high flow rate of the fluid to be filtered in such a way that it could pass the pore structure and the pores of the individual wound body layers or windings 46 which pores are arranged at least partially displaced relative to each other.

In most technical applications, fiberglass particles that are larger than 200 μm are particularly critical, particularly because they can cause damage at devices which are arranged fluidically downstream of the filter system. In the automotive sector, this concerns, for example, the high-pressure injection pump of an internal combustion engine, the injectors as well as the internal combustion engine itself.

In FIG. 4, the number of fiberglass particles that has been measured in a test set-up without use of a barrier layer in a predetermined volume of a fluid that has been passed through a fiberglass-containing filter medium 26 (FIG. 1), established in fuel filtration, as a function of the maximum particle size L (FIG. 1) of the fiberglass fibers 38. The particle size L is here the maximum Feret diameter that has been determined by measuring technology and, for reasons of illustration in FIG. 4, is shown divided into particle fractions. The fuel contained more than 900 fiberglass particles with a size between 50 μm and 100 μm and in total still more than 300 fiberglass particles larger than 200 μm.

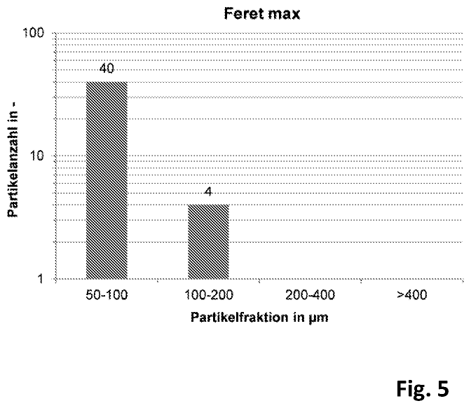

The average pore size of the wound body 40 (FIG. 1) according to the invention is selected such that fiberglass particles with a size of more than 200 μm according to the diagram illustrated in FIG. 5 are completely retained and fiberglass particles 38 with a length between 50 μm and 200 μm are filtered out by more than 95% from the fluid. Accordingly, a large proportion of the aforementioned secondary damages at devices which are arranged fluidically downstream of the filter element/filter system can be avoided. The wound body 40 which serves as a fiberglass barrier can be arranged, according to an embodiment which is not illustrated in detail in the drawing, also on a support body 42 that is embodied as an integral component of the filter housing 16 (FIG. 1). In particular, the support body 42 can be designed in the form of a central tube 44 which is connected as one piece together with the filter housing 12, i.e., the housing pot 16 or the (annular) cover 20. When the filter element is arranged in its predetermined mounted position in the filter housing, the support body 42 extends with the wound body 40 wound thereon at least in sections in axial direction into the filter element 14. When the filter element 14 is exchanged, the wound body 40 together with the support body remains at the filter housing 12. The wound body 40 includes in this context a structure which has been described above in connection with FIG. 3.

What is claimed is:

1. A filter system for filtering a fluid, the filter system comprising:
a filter housing comprising an inlet for the fluid to be filtered and an outlet for the filtered fluid;
a filter element arranged in the filter housing and comprising a fiberglass-containing filter medium;
a fiberglass barrier configured to retain fiberglass particles contained in the filtered fluid, wherein the fiberglass barrier is arranged fluidically downstream of the fiberglass-containing filter medium;
wherein the fiberglass barrier is a wound body comprising a wound filter material with an average pore size of smaller than 20 μm;
wherein the wound body comprises a maximum winding thickness of 1.5 mm.

2. The filter system according to claim 1, wherein the filter material of the wound body comprises a maximum thickness that amounts to between 0.1 mm and 1.5 mm.

3. The filter system according to claim 1, wherein the wound body comprises one to four windings of the filter material.

4. The filter system according to claim 3, wherein the wound body comprises precisely two of the windings of the filter material.

5. The filter system according to claim 1, wherein the filter material of the wound body is selected from the group consisting of a nonwoven, a knit material, a knotted material, and a woven material.

6. The filter system according to claim 5, wherein the nonwoven is comprised of meltblown fibers.

7. The filter system according to claim 1, further comprising a support body, wherein the wound body is arranged and held on the support body.

8. The filter system according to claim 7, wherein the support body is a sleeve.

9. The filter system according to claim 7, wherein the support body is an integral component of the filter housing or an integral component of the filter element.

10. The filter system according to claim 1, wherein the filter material of the wound body comprises an air permeability of 10 l/(cm²*s) to 80 l/(cm²*s).

11. The filter system according to claim 10, wherein the air permeability is <50 l/(cm²*s)

12. The filter system according to claim 11, wherein the air permeability is <30 l/(cm²*s).

13. A filter element for filtering a fluid, the filter element comprising:
a fiberglass-containing filter medium;
a fiberglass barrier arranged fluidically downstream of the fiberglass-containing filter medium and configured to retain fiberglass particles contained in the filtered fluid;
wherein the fiberglass barrier is a wound body comprising a wound filter material with an average pore size of smaller than 20 μm;
wherein the wound body comprises a maximum winding thickness of 1.5 mm.

14. The filter element according to claim 13, wherein the filter material of the wound body comprises a maximum thickness between 0.1 and 1.5 mm.

15. The filter element according to claim 13, wherein the filter material of the wound body is selected from the group consisting of a nonwoven, a knit material, a knotted material, and a woven material.

16. The filter system according to claim 15, wherein the nonwoven is comprised of meltblown fibers.

17. The filter element according to claim 13, wherein the filter material of the wound body comprises a grammage that amounts to 20 g/m² to 200 g/m².

18. The filter element according to claim 13, wherein the filter material of the wound body comprises an air permeability of 10 l/(cm²*s) to 80 l/(cm²*s).

19. The filter element according to claim 18, wherein the air permeability is <50 l/(cm²*s)

20. The filter element according to claim 19, wherein the air permeability is <30 l/(cm²*s).

21. The filter element according to claim 13, further comprising a support body, wherein the wound body is arranged and held on the support body.

22. The filter element according to claim 21, wherein the support body is a grid-shaped central tube of the filter element.
